(19) United States
(12) Patent Application Publication
(10) Pub. No.: US 2010/0259669 A1
(43) Pub. Date: Oct. 14, 2010

(54) Follow Focus Camera Accessory Device

(76) Inventor: Dennis Wood, Thunder Bay (CA)

Correspondence Address: ADE & COMPANY INC., 2157 Henderson Highway, WINNIPEG, MB, R2G1P9, CA

(21) Appl. No.: 12/420,495

(22) Filed: Apr. 8, 2009

(51) Int. Cl. G03B 13/18

(52) U.S. Cl. 348/345; 348/E05.045

(57) ABSTRACT

A focussing accessory device comprises a focussing ring rotatable with a focussing control of a video camera rotatable responsive to rotation of a control knob. A main body of the device is supported on a single mounting rail of a camera assembly for relative pivotal movement to adjust an orientation of the device relative to the camera. The control knob is coupled to an input of a transmission on the main body. An output of the transmission meshes in engagement with the focussing ring. The transmission is reversibly supported on the main body to reverse the location and orientation of the output. An index marker is provided for rotation about an axis of the control knob independently therefrom. An annular indexing member is selectively coupled for rotation with the control knob relative to the index marker by magnetic elements which permit mounting in only one relative orientation.

### FIELD OF THE INVENTION

The present invention relates to a focussing accessory device for a camera, and more particularly relates to a follow focus device to provide auxiliary control of the manual focus of a lens of a video camera.

### BACKGROUND

It is common in the use of video cameras to additionally make use of a follow focus accessory device. The follow focus device generally comprises a rotatable control knob which rotates relative to an index marker and which in turn rotates an output member that meshes with a corresponding focusing ring supported about the lens of the camera for rotation with a rotating component of the lens used for focusing.

Examples of follow focus devices are available by Zacuto and Chrosziel. In each instance a base is provided which requires anchoring to two spaced apart mounting rails of a camera mounting assembly in order to provide proper support to the device. In some examples a complex arrangement of parts is required to permit relative sliding along a horizontal axis, a vertical axis, or both in order to align the device with the lens of the camera. In another example in the prior art, a complex transmission arrangement is required in order to pivot the output member relative to the input of the control knob. In each instance in the prior art due to the mounting configuration on two spaced apart mounting rails of the camera assembly, and due to the limited adjustment ability of the control knob and output relative to the rail mounts, very few mounting orientations are permitted so that it is difficult to make use of the follow focus device in a variety of applications.

### SUMMARY OF THE INVENTION

According to one aspect of the invention there is provided a focussing accessory device for use with a video camera system including a mounting rail extending in a longitudinal direction along a rail axis, a camera body fixed relative to the mounting rail and a lens coupled to the camera body and supported on the mounting rail so as to be directed in the longitudinal direction for capturing an image, the lens having a focussing element arranged to provide adjustable focus to the lens and a focussing control rotatable about a focussing axis of the lens to adjust the focussing element of the lens, the device comprising:

a focussing ring arranged to be supported about the lens and coupled to the focussing control so as to be arranged to rotate with the focussing control about the focussing axis of the lens;

a main body extending between a rail mounting end and a working end;

a mount at the rail mounting end of the rail arranged to mount the main body onto the mounting rail;

a transmission supported on the main body adjacent the working end, the transmission comprising:
an output member supported for rotation about an output axis which is parallel to and spaced apart from the focussing axis such that the output member is arranged for meshing engagement with the focussing ring; and
an input member coupled to the output member such that the output member is rotated responsive to rotation of the input member; and

a control knob supported on the input member for rotation therewith relative to the main body about a control axis;

the mount being arranged to support the main body for pivotal movement about a longitudinal axis arranged to be oriented parallel to the mounting rail such that the transmission is pivotal together with the main body about the longitudinal axis.

By providing a mount which is permitted to pivot about a single mounting rail, a follow focus device is provided which can be mounted in an unlimited amount of configurations as the device can readily be reversed along the mounting rail or slidably displaced along the rail while optionally being mounted on a different one of the two mounting rails of a camera assembly. In yet further arrangements the single rail mounting configuration is also convenient for supporting the follow focus accessory device on an auxiliary mounting rail supported on a cage for example. The configuration of the input to the output of the transmission is thus reversible along the same rail for changing the direction of the output relative to the input as well as being reversible to the other rail for similarly changing the direction of rotation on either side of the camera lens. Due to the pivoting arrangement of the main body relative to the mounting rail location of the output can be readily adjusted for engaging a focusing ring on the lens without any complex placement of slides or transmission reconfigurations being required as in the prior art devices.

The longitudinal axis is preferably coaxial with the rail axis such that the mount is arranged to support the main body for pivotal movement about the mounting rail.

The mount may comprise a clamp member arranged to selectively fix the main body relative to the mounting rail at any one of a plurality of different mounting positions angularly offset relative to one another about the longitudinal axis.

The control axis is preferably supported for pivotal movement relative to the main body about a secondary axis oriented transversely to the control axis.

There may be provided a clamp member arranged to selectively fix orientation of the control axis relative to the main body at any one of a plurality of different mounting positions angularly offset relative to one another about the secondary axis.

The secondary axis may comprise the output axis of the output member such that the control knob on the input member and the transmission are supported for pivotal movement together relative to the main body about the output axis.

The control knob on the input member and the transmission may be supported for pivotal movement together relative to the main body through a range of at least 180 degrees.

The mount may comprise two mounting portions which are spaced apart from one another in a direction of the longitudinal axis in which each mounting portion comprises a generally C-shaped member arranged to be clamped about the mounting rail. Preferably he two mounting portions are integrally formed with the main body at a first end and are joined by a bridge portion at a second end such that the two mounting portions are arranged to be clamped about the mounting rail by a common fastener coupled between the bridge portion and the main body.

The working end of the main body may comprise two mounting portions which are spaced apart in a direction of the output axis and which are arranged to support the transmission therebetween.

According to a second aspect of the present invention there is provided a focussing accessory device for use with a video camera system including a mounting rail extending in a longitudinal direction along a rail axis, a camera body fixed relative to the mounting rail and a lens coupled to the camera body and supported on the mounting rail so as to be directed in the longitudinal direction for capturing an image, the lens having a focussing element arranged to provide adjustable focus to the lens and a focussing control rotatable about a focussing axis of the lens to adjust the focussing element of the lens, the device comprising:

a focussing ring arranged to be supported about the lens and coupled to the focussing control so as to be arranged to rotate with the focussing control about the focussing axis of the lens;

a main body extending between a rail mounting end and a working end;

a mount at the rail mounting end of the rail arranged to mount the main body onto the mounting rail;

a transmission supported on the main body adjacent the working end, the transmission comprising:
an output member supported for rotation about an output axis which is parallel to and spaced apart from the focussing axis such that the output member is arranged for meshing engagement with the focussing ring; and
an input member coupled to the output member such that the output member is rotated responsive to rotation of the input member; and

a control knob supported on the input member for rotation therewith relative to the main body about a control axis;

the working end of the main body comprising two mounting portions which are spaced apart in a direction of the output axis and which are arranged to support the transmission reversibly therebetween in either one of a first position in which the output member is rotatable in a first direction about the output axis responsive to rotation of the control knob in a forward direction about the control axis or a second position in which the output member is rotatable in a second direction about the output axis opposite to the first direction responsive to rotation of the control knob in said forward direction about the control axis.

By further providing a transmission which can be readily mounted in two reversible orientations between spaced apart mounting portions of the main body, the direction of rotation of the output relative to the input can be further adjusted without altering the orientation of the main body relative to the mounting rail. Providing a transmission which is readily reversible as an integral unit provides a simple reconfigurable structure which is highly adaptable to various configurations and different applications or desired uses of the focusing accessory device.

According to a third aspect of the present invention there is provided a focussing accessory device for use with a video camera system including a mounting rail extending in a longitudinal direction along a rail axis, a camera body fixed relative to the mounting rail and a lens coupled to the camera body and supported on the mounting rail so as to be directed in the longitudinal direction for capturing an image, the lens having a focussing element arranged to provide adjustable focus to the lens and a focussing control rotatable about a focussing axis of the lens to adjust the focussing element of the lens, the device comprising:

a focussing ring arranged to be supported about the lens and coupled to the focussing control so as to be arranged to rotate with the focussing control about the focussing axis of the lens;

a main body extending between a rail mounting end and a working end;

a mount at the rail mounting end of the rail arranged to mount the main body onto the mounting rail;

a transmission supported on the main body adjacent the working end, the transmission comprising:
an output member supported for rotation about an output axis which is parallel to and spaced apart from the focussing axis such that the output member is arranged for meshing engagement with the focussing ring;
an input member coupled to the output member such that the output member is rotated responsive to rotation of the input member; and
a transmission housing supporting the output member and the input member rotatably thereon;

a control knob supported on the input member for rotation therewith relative to the main body about a control axis;

an annular indexing member supported for rotation with the control knob and the input member about the control axis; and

an index marker supported adjacent a periphery of the annular indexing member, the index marker being supported on the transmission housing for rotation about the control axis relative to the transmission housing independently of the annular indexing member and control knob.

Use of an index marker which is rotatable about the control axis independently of the indexing member further increases the flexibility of mounting configurations as the index marker relative to which the annular indexing member is rotated can be located to best suit the orientation of the control knob and main body relative to the mounting rail upon which it is supported. The increased customization by the user which is permitted ensures that the focusing accessory device is more adaptable to different applications than prior art devices intended for similar use.

There may be provided a set screw arranged to selectively fix orientation of the index marker relative to the transmission housing in which the set screw is located diametrically opposite the index marker about the control axis.

According to another aspect of the present invention there is provided a focussing accessory device for use with a video camera system including a mounting rail extending in a longitudinal direction along a rail axis, a camera body fixed relative to the mounting rail and a lens coupled to the camera body and supported on the mounting rail so as to be directed in the longitudinal direction for capturing an image, the lens having a focussing element arranged to provide adjustable focus to the lens and a focussing control rotatable about a focussing axis of the lens to adjust the focussing element of the lens, the device comprising:

a focussing ring arranged to be supported about the lens and coupled to the focussing control so as to be arranged to rotate with the focussing control about the focussing axis of the lens;

a main body extending between a rail mounting end and a working end;

a mount at the rail mounting end of the rail arranged to mount the main body onto the mounting rail;

a transmission supported on the main body adjacent the working end, the transmission comprising:
an output member supported for rotation about an output axis which is parallel to and spaced apart from the focussing axis such that the output member is arranged for meshing engagement with the focussing ring; and
an input member coupled to the output member such that the output member is rotated responsive to rotation of the input member;

a control knob supported on the input member for rotation therewith relative to the main body about a control axis;

an index marker supported on the main body;

an indexing mount supported on the input member for rotation with the input member and the control knob about the control axis; and

an annular indexing member arranged to be supported on the indexing mount for rotation therewith relative to the index marker supported on the main body;

the index mount being arranged to support the annular indexing member thereon in only one relative orientation and such that the annular indexing member is readily removable from the index mount.

By ensuring the annular indexing member can only be mounted in a single orientation relative to the control knob, errors resulting from improper placement of the annular indexing member are prevented. In this manner the convenience of having a quick and readily releasable structure which can be replaced for different indexing scenarios can be realised without introducing any further complications of misalignment of the annular indexing member with its intended mounting orientation.

One or both of the index mount and the annular indexing member may comprise one or more magnetic coupling elements arranged to magnetically support the annular indexing member on the index mount. More preferably there is provided a plurality of magnetic coupling elements supported circumferentially about the index mount and the annular indexing member in alignment with one another in which at least some of the magnetic coupling elements on each of the index mount and the annular indexing member having a magnetic flux oriented in a different direction relative to one another. In this manner the magnetic coupling elements are arranged to magnetically couple the annular indexing member to the index mount in only one relative orientation.

One embodiment of the invention will now be described in conjunction with the accompanying drawings in which:

### BRIEF DESCRIPTION OF THE DRAWINGS

FIG. 1 is a side elevational view of the focusing accessory device supported on a camera assembly.

FIG. 2 is an elevational view along the line 2-2 of FIG. 1.

FIG. 3 and FIG. 4 are perspective views of the focusing accessory device showing an inner side and an outer side of the device respectively.

FIG. 5 is a top plan view of the device.

FIG. 6 is an outer side elevational view of the device.

FIG. 7 is an inner side elevational view of the device.

FIG. 8 is a perspective view of the outer side of the device in which the annular indexing member is shown separated from the index mount.

FIG. 9 is a top plan view of the device in which the control knob, indexing assembly and transmission housing are shown removed.

In the drawings like characters of reference indicate corresponding parts in the different figures.

### DETAILED DESCRIPTION

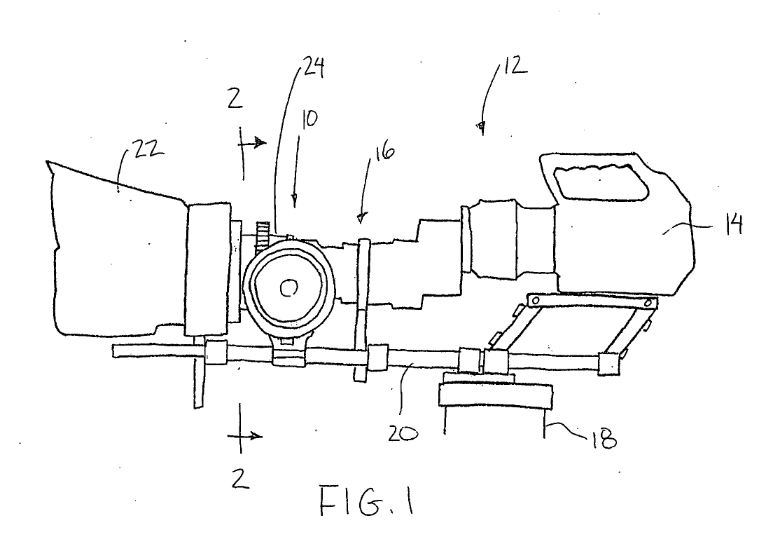

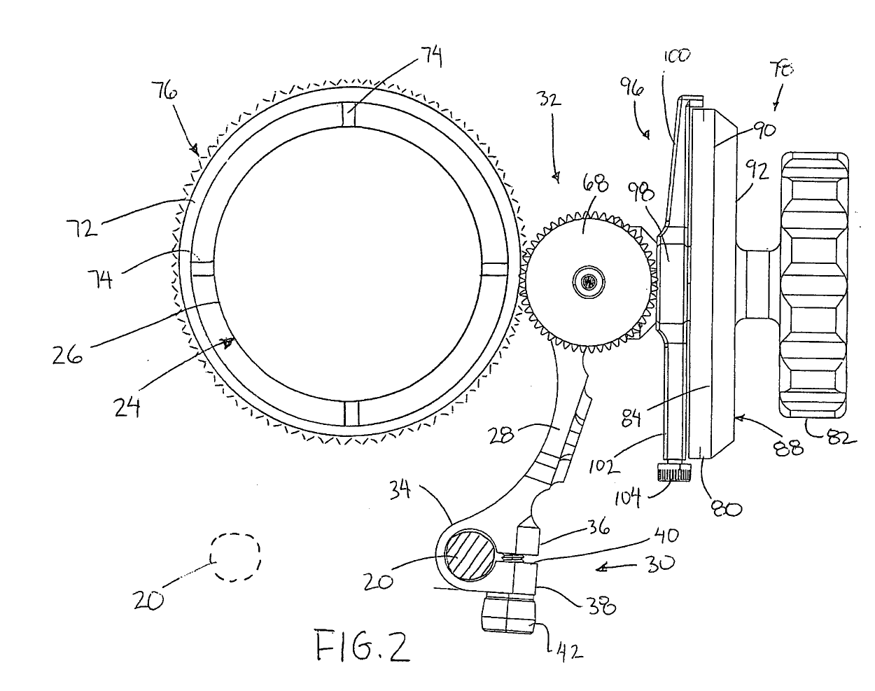

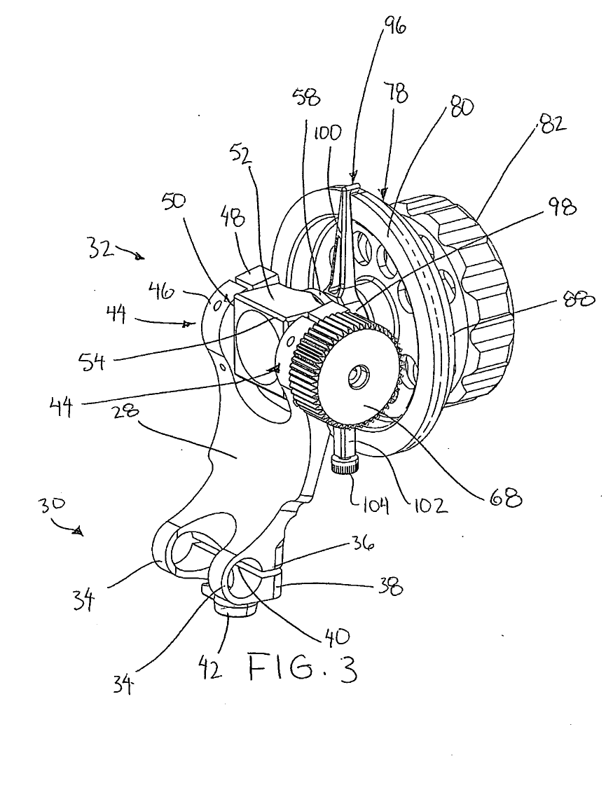

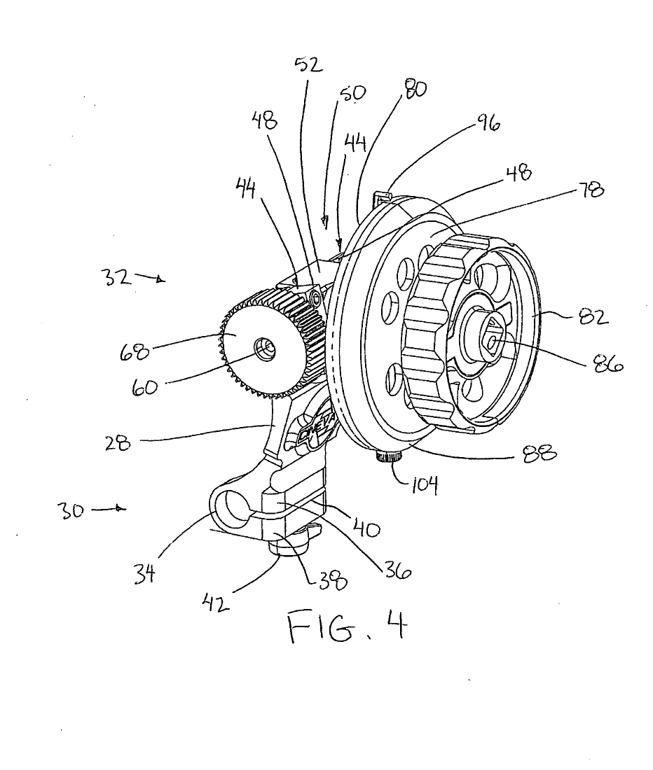

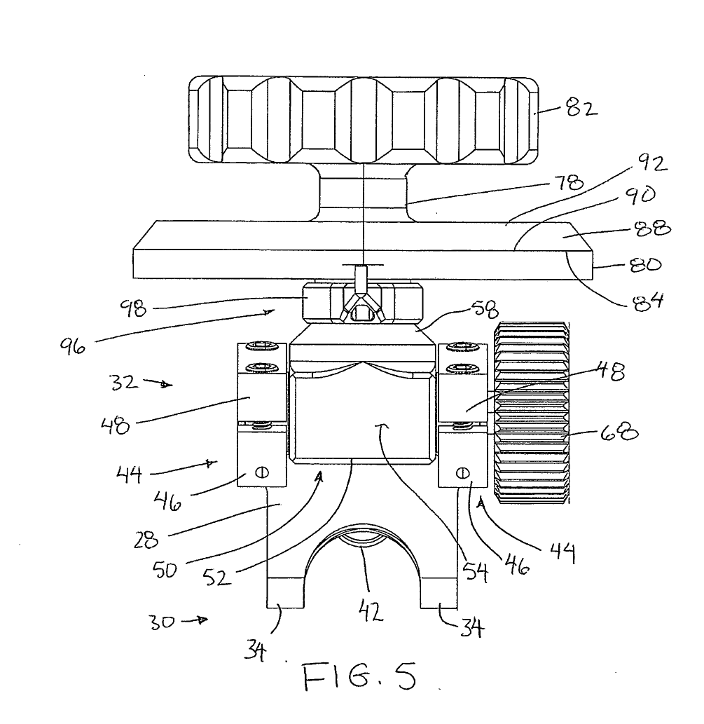

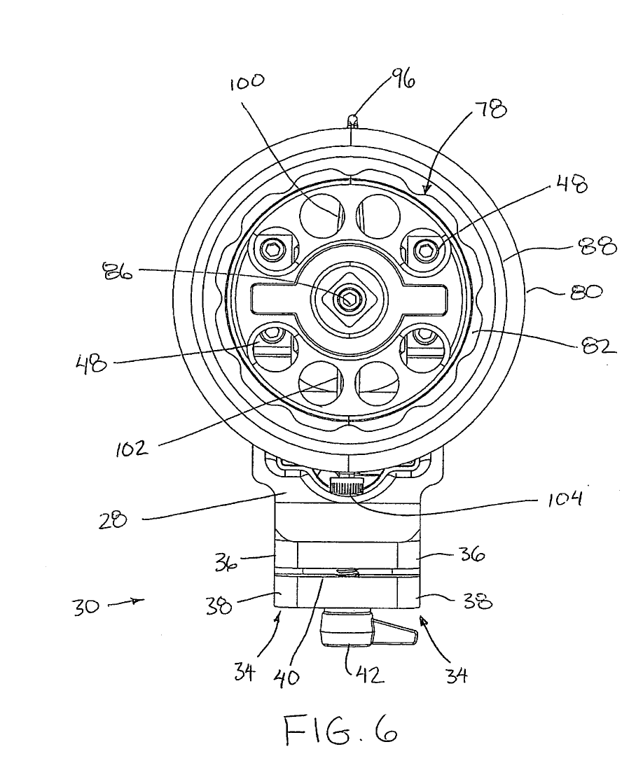

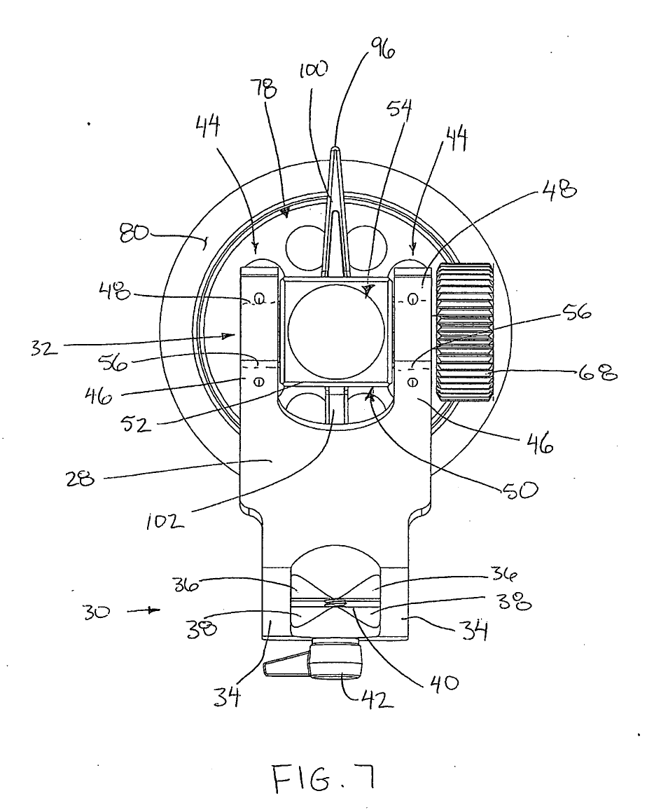

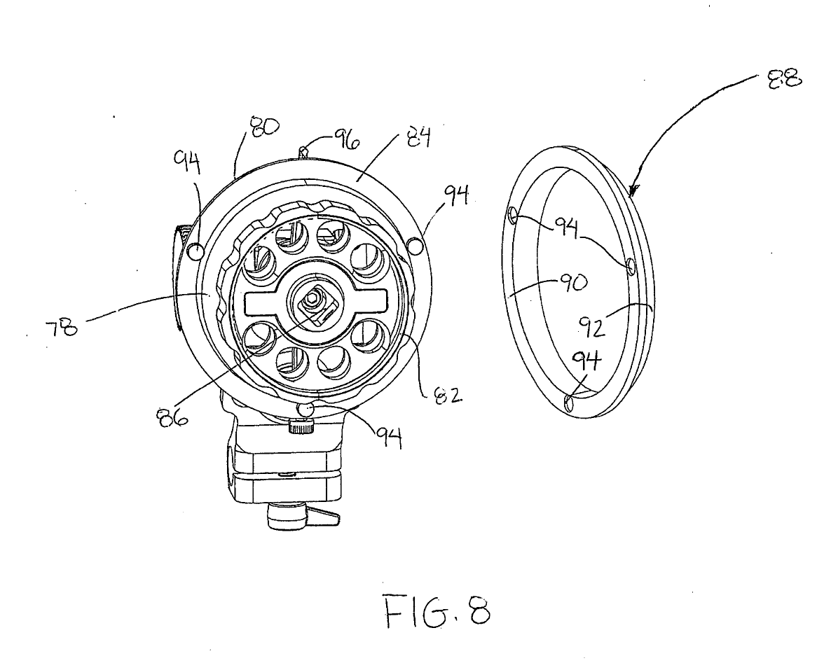

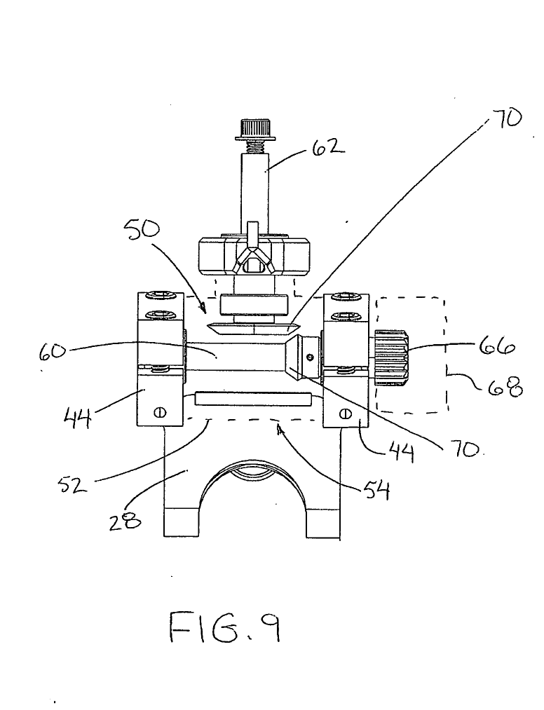

Referring to the accompanying figures there is illustrated a camera focusing accessory device generally indicated by reference numeral 10. The device 10 is suited for use with a video camera assembly 12 of the type shown in FIG. 1.

The video camera assembly 12 typically comprises a camera body 14 which is directed in a longitudinal direction for capturing images through a lens assembly 16 coupled to the camera body. The camera assembly is commonly supported on a supporting structure such as a tripod 18 by a pair of mounting rails 20 which extend in the longitudinal direction parallel and spaced apart from one another. The mounting rails are typically fixed to the top of the tripod 18 and the camera body 14 and lens assembly 16 are then supported on the mounting rails using suitable mounting hardware. Additional components of the camera assembly, for example a matte box 22 can also be supported on the mounting rails. Each of the mounting rails in the illustrated embodiment comprises a rod which is circular in cross section and which extends in the longitudinal direction along a respective rail axis.

The lens assembly 16 includes a focusing element 24 arranged to provide adjustable focus to the lens and image captured by the camera. The focusing element 24 includes a focusing control ring 26 supported about the housing of the focusing element for rotation about a focusing axis extending in the longitudinal direction of the camera assembly, parallel to the rail axis. Rotation of the focusing control adjusts the focus of the focusing element.

The device 10 generally comprises a main body 28 comprising a unitary body extending between a rail mounting end 30 arranged to be supported wholly on a single one of the mounting rails of the camera assembly and an opposing working end 32 supporting the operating components of the device.

The rail mounting end 30 generally comprises two mounting portions 34 which are axially spaced apart in the direction of the longitudinal rail axis. Each of the two mounting portions comprises a generally C-shaped clamping member having a central aperture therein arranged to receive the mounting rail therethrough in which the apertures of the two mounting portions are aligned for receiving a common one of the mounting rails therethrough. The dimensions of the two clamping members forming the two mounting portions 34 are in close tolerance to the diameter of the mounting rail to support the main body for rotation about the longitudinal axis or rail axis of the rail as well as supporting the main body for sliding movement along a length of the axis relative to the mounting rail.

Each C-shaped clamping member defining one of the mounting portions extends circumferentially about the mounting rail between the first end 36 of the clamping member which is commonly and integrally joined with the main body 28 and an opposing second end 38 opposite the first end 36 but in close proximity thereto. The two second ends 38 are commonly joined by a bridge portion 40 extending in the direction of the longitudinal axis between the two mounting portions which are spaced apart.

The two mounting portions 34 are commonly clamped about the mounting rail by a single common fastener 42 which is coupled between the bridge portion 40 and the remainder of the main body 28 to bridge the gap between the first and second ends of the two C-shaped mounting portions. The fastener 42 is centrally located in the longitudinal direction between the two mounting portions 34 such that tightening the fastener 42 serves to clamp the bridge portion 40 towards the remainder of the main body 28 to close and clamp the two C-shaped mounting portions 34 about the rail substantially evenly relative to the one another. The common fastener 42 permits the mounting portion 34 to be clamped about the rail at any desired angular orientation or position along the rail. In this manner the main body can be fixed relative to the mounting rail at any one of a plurality of different mounting positions in which at least some of the positions are angularly offset relative to one another about the longitudinal rail axis of the apertures of the mounting portions 34 and of the mounting rail received therethrough.

The working end 32 of the main body 28 also comprises two mounting portions 44 in which each mounting portion is arranged to be clamped about a respective central aperture and in which the central apertures of the two mounting positions 44 at the working end are axially spaced and oriented about a common secondary axis which lies parallel to the longitudinal axis extending between the two mounting portions 34 at the rail mounting end and to the rail axis of the mounting rail upon which they are supported. Each of the two mounting portions 44 includes a first integral portion 46 which is partially C-shaped to extend partway about the central aperture and a second clamp portion 48 which extends about an opposing portion of the circumference about the central aperture and which is joined to the integral portion 46 by suitable fasteners at diametrically opposed positions. Accordingly tightening the fasteners causes the clamp portion 48 and the integral portion 46 of each mounting portion to be clamped from diametrically opposing sides of the central aperture.

A transmission 50 is provided comprising a housing 52 which is supported by the two mounting portions 44 at the working end of the main body. The transmission housing 52 comprises a central portion 54 which spans between the two mounting portions 44 as well as a pair of axially opposed end portions 56 which extend outwards from opposing ends of the central portion 54 for being received within the respective central apertures of the two mounting portions 44. The end portions 56 are generally tubular to be rotatably received within the apertures of the two mounting portions 44 so that orientation of the transmission housing can be adjusted relative to the main body about the secondary axis extending between the two mounting portions 44 parallel to the longitudinal axis and rail axis. Tightening the fasteners which clamp the clamp portions 48 to the integral portions 46 of each mounting portion 44 permits the mounting portions to be selectively clamped about the end portions 56 of the transmission housing. In this manner orientation of the transmission housing relative to the main body can be selectively fixed at any one of a plurality of different mounting positions which are angularly offset relative to one another about the secondary axis.

The transmission housing further comprises an intermediate portion 58 which is generally tubular and which is supported centrally between the two axially opposed ends to extend outward about a control axis oriented perpendicularly to the secondary axis. The intermediate portion 58 and the control axis defined by the tubular intermediate portion are rotatable together with the housing relative to the main body about the secondary axis.

The transmission housing 52 rotabably supports an output shaft 60 and an input shaft 62 therein. The output shaft 60 is supported for rotation about an output axis which coincides with the secondary axis of rotation of the transmission housing. The output shaft 60 spans between bearings which rotatably support the output shaft at the axially opposed end portions 56 of the housing. The shaft 60 extends axially through and beyond one end of the housing and the mounting portion 44 through which it is received to support an output member externally on the end of the output shaft 60. The output member generally comprises a sprocket member 66 fixed onto the shaft and which received within the socket of a surrounding drive gear 68 which rotates together with the sprocket member and output shaft 60 about the output axis lying along the secondary axis of the transmission housing.

The input shaft 62 extends through the intermediate portion 58 of the transmission housing along the control axis for rotation relative to the housing by being supported on respective bearings. The input shaft is rotatable about the longitudinally extending control axis so as to be rotatable about an axis which is perpendicular to the output axis. The input shaft 62 is pivotal with the transmission housing 52 about the secondary axis relative to the main body for adjusting orientation of the control axis about which the input shaft is rotatable relative to the main body and the mounting rail upon which it supported.

The axially opposed end portions 56 of the transmission housing are reversibly mounted within the respective apertures of the two mounting portions 44 of the main body such that the transmission can be reversibly mounted in either one of a first or second position. In the first position the output member is rotatable in a first direction of rotation about the respective output axis responsive to rotation of the input shaft in a first forward direction about the control axis. Alternatively in a second position in which the transmission is reversed relative to the first position, the output member is rotatable in a second direction about the output axis opposite the first direction in response to rotation of the input shaft in the same first forward direction about the control axis.

Co-operating bevel gears 70 are mounted on the inner end of the input shaft terminates adjacent the output shaft 4 and on the output shaft between the two ends thereof for communication with the bevel gear on the input shaft in meshing engagement with one another. The meshing engagement of the bevel gears ensures that the output shaft rotates responsive to rotation of the input shaft in a consistent ratio.

The drive gear 68 of the output member of the transmission is arranged for meshing engagement with a focusing ring 72 supported on the lens assembly. The focusing ring 72 comprises an annular member about the focusing control ring 26 of the lens assembly so as to be coaxial therewith about the focusing axis. A plurality of circumferentially spaced mounts 74 extend radially inward from the focusing ring 72 to the control ring 26 for selectively fixing the focusing ring onto the control ring for rotation together about the focusing axis. A plurality of teeth 76 about the outer peripheral surface of the focusing ring 72 define a driven gear which meshes in engagement with the drive gear 68 at the output of the transmission.

The diameter of the driven gear is approximately three times the diameter of the drive gear 68 such that the circumference and number of teeth is at least twice as many or near three times as many in the driven gear as compared to the drive gear. A much greater rotation of the input shaft is thus required to effect a comparable range of angular rotation of the control ring 26 on the lens assembly to increase the precision of manual focus control of the lens assembly.

The input shaft of the transmission is rotatably supported through the intermediate portion of the transmission housing for communication between the bevel gears internally within the transmission housing and an input body 78 external of the transmission housing and which rotates with the input shaft about the control axis. The input body is fixed onto the outer end of the input shaft by a suitable set screw fastened axially through the end of the shaft.

The input body 78 comprises an index mount 80 and a control knob 82 which are rotatable together with the input shaft about the control axis. The index mount 80 comprises a generally circular mounting plate having an annular mounting face 84 which lies in a plane oriented generally perpendicular to the control axis and which rotates with the input shaft. The control knob 82 extends axially outward from the index mount 80 and has a smaller diameter. The control knob 82 has a textured peripheral surface which is suitable for gripping in the hand of a user to manually control rotation of the input shaft of the transmission.

A central socket 86 is provided centrally in the end face of the control knob 82 to provide a standard connection for releasably attaching a flexible control member, or a radially extending handle thereto.

A plurality of axially extending apertures extend through the control knob and the index mount at circumferentially spaced positions about the control axis for access of a suitable fastening tool through the input body to the fasteners which serve to clamp the clamping portions 48 of the two mounting portions 44 of the main body.

In addition to the index mount 80, an indexing assembly is provided which further comprises an annular indexing member 88 which is arranged to mount onto the annular mounting face of the index mount. The annular indexing member 88 includes a rear mounting face 90 which is generally annular and arranged to lie perpendicular to the control axis for mating against the mounting face 84 of the index mount in a mounted position. The annular indexing member 88 further comprises a front outer face 92 which is generally smooth and frusto-conical in shape. The outer face comprises a suitable smooth plastic material which can accept markings from a dry erase ink marking pen so as to remain erasable thereon.

A plurality of magnetic coupling elements 94 are provided at three evenly circumferentially spaced positions about each of the rear mounting face 90 of the annular indexing member 88 and the mounting face 84 of the index mount 80. The coupling elements 94 on the index mount comprise protrusions which protrude axially outward from the mounting face to be received within corresponding sockets on the mounting face of the index member which mount the coupling elements 94 respectively therein.

Of the three magnetic coupling elements 94 on the index mount, one has a different flux orientation than the other two with the corresponding magnetic coupling elements on the annular index member having a similar flux orientation. In this manner only one of the three aligned positions of the magnetic coupling elements between the index mount and the indexing member results in the magnetic elements being arranged for magnetically coupling the two components together while the other orientations would result in at least two of the magnets being oriented to magnetically repel the two components relative to one another. In this manner only a single mounting orientation of the annular indexing member relative to the index mount is permitted. In the single mounting orientation, the magnetic coupling of the elements 94 ensures that the annular indexing member 88 is readily removable and replaceable if desired.

The annular indexing member cooperates with an indexing marker 96 of the indexing assembly which serves to indicate a single reference point at the periphery of the annular indexing member. The indexing marker 96 is arranged to be mounted at a selected position in proximity to the periphery of the annular indexing member to indicate a reference point relative to which the index member is rotated. The indexing marker 96 comprises a central hub 98 which is supported rotatably on the intermediate tubular portion of the transmission housing so that the indexing marker 96 is rotatable about the control axis relative to the transmission housing independently of the rotation of the input shaft extending internally through the intermediate portion of the housing. Accordingly rotation of the control knob and annular indexing member 88 together with the input shaft can be performed regardless of the positioning of the indexing member which is rotated externally about the intermediate portion of the transmission housing to a desired reference location.

More particularly the indexing marker 96 includes a first arm 100 extending radially outward from the control axis from the central hub 98 to a free end having a pointed indicator thereon at the periphery of the annular index member. The pointed end extends radially beyond the indexing member so as to be visible from the outer side when the indexing marker is mounted along the inner side of the input body. Furthermore the index marker comprises a second arm 102 which is diametrically opposite the first arm in relation to the control axis and which extends radially outward to a respective free end which is also near a periphery of the input body 78. The second arm 102 locates a suitable set screw 104 extending radially therethrough and through the central hub 98 for selective engagement with the intermediate portion of the transmission housing about which the central hub 98 is supported. Tightening the set screw fixes the location of the central hub 98 relative to the transmission housing to accordingly fix the location of the index marker 96.

In use the accessory device 10 is suited for mounting onto one of the mounting rails of a camera assembly with the main body being pivoted about the mounting rail until the drive gear of the output member engages the focusing ring supported about the control ring on the lens assembly. Once mounted, rotation of the control knob results in a corresponding rotation of the control ring to focus the lens. The simple configuration of the mount at the mounting end of the body permits reversible mounting on either one of the mounting rails of the camera assembly so that multiple different orientations and directions of rotation can be achieved responsive to the input rotation of the control knobs. The single rail mounting configuration further permits mounting on an auxiliary rail, such as a mounting rail extending above the camera assembly which is anchored on a surrounding camera cage.

In any of the mounting positions of the main body, the orientation of the control knob together with the control axis and the transmission housing are rotatable about the secondary axis of the transmission or corresponding output axis of the output member to accommodate the preference of the user. Flipping the transmission housing through a range of 180° or more permits the control knob to be relocated from an inner side to an outer side of the main body which in turn reverses the corresponding orientation of the drive gear when mounted in a reverse orientation on the mounting rails. By flipping the orientation of the transmission relative to the main body and in turn flipping the main body relative to the mounting rail to be mounted in a reverse orientation, the drive gear on the output member can again be engaged with the focusing ring but may be located at the trailing side of the main body instead of the leading side thereof in the longitudinal direction which the camera is directed. This accommodates further flexibility in mounting configurations of the camera assembly and other accessories thereon.

Instead of flipping the control knob relative to the main body, further flexibility can be provided by instead reversing the mounting orientation of the transmission within the two mounting portions of the main body by reversing the mounting of the end portions of the transmission housing within the respective mounting portions.

Further customization is achieved to accommodate yet further user preferences by adjusting the location of the index marker by releasing the corresponding set screw and pivoting the index marker about the control axis independently of the control knob. Once the reference point indicated by the index marker is located at the desired location in a convenient position for the selected user preference, the user can then mark suitable reference markings on the replaceable annular index member. The mounting configuration of the magnets ensures that the annular index member can be removed and reattached or replaced with other index members while always ensuring that the members are replaced at the correct orientation relative to the control knob due to the varying flux orientation of the magnetic coupling elements.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A focussing accessory device for use with a video camera system including a mounting rail extending in a longitudinal direction along a rail axis, a camera body fixed relative to the mounting rail and a lens coupled to the camera body and supported on the mounting rail so as to be directed in the longitudinal direction for capturing an image, the lens having a focussing element arranged to provide adjustable focus to the lens and a focussing control rotatable about a focussing axis of the lens to adjust the focussing element of the lens, the device comprising:
a focussing ring arranged to be supported about the lens and coupled to the focussing control so as to be arranged to rotate with the focussing control about the focussing axis of the lens;
a main body extending between a rail mounting end and a working end;
a mount at the rail mounting end of the rail arranged to mount the main body onto the mounting rail;
a transmission supported on the main body adjacent the working end, the transmission comprising:
an output member supported for rotation about an output axis which is parallel to and spaced apart from the focussing axis such that the output member is arranged for meshing engagement with the focussing ring; and
an input member coupled to the output member such that the output member is rotated responsive to rotation of the input member; and
a control knob supported on the input member for rotation therewith relative to the main body about a control axis;
the mount being arranged to support the main body for pivotal movement about a longitudinal axis arranged to be oriented parallel to the mounting rail such that the transmission is pivotal together with the main body about the longitudinal axis.

2. The device according to claim 1 wherein the longitudinal axis is coaxial with the rail axis such that the mount is arranged to support the main body for pivotal movement about the mounting rail.

3. The device according to claim 1 wherein the mount comprises a clamp member arranged to selectively fix the main body relative to the mounting rail at any one of a plurality of different mounting positions angularly offset relative to one another about the longitudinal axis.

4. The device according to claim 1 wherein the control axis is supported for pivotal movement relative to the main body about a secondary axis oriented transversely to the control axis.

5. The device according to claim 4 wherein there is provided a clamp member arranged to selectively fix orientation of the control axis relative to the main body at any one of a plurality of different mounting positions angularly offset relative to one another about the secondary axis.

6. The device according to claim 4 wherein the secondary axis comprises the output axis of the output member such that the control knob on the input member and the transmission are supported for pivotal movement together relative to the main body about the output axis.

7. The device according to claim 4 the control knob on the input member and the transmission are supported for pivotal movement together relative to the main body through a range of at least 180 degrees.

8. The device according to claim 1 wherein the mount comprises two mounting portions which are spaced apart from one another in a direction of the longitudinal axis, each mounting portion comprising a generally C-shaped member arranged to be clamped about the mounting rail.

9. The device according to claim 8 wherein the two mounting portions are integrally formed with the main body at a first end and are joined by a bridge portion at a second end, the two mounting portions being arranged to be clamped about the mounting rail by a common fastener coupled between the bridge portion and the main body.

10. The device according to claim 1 wherein the working end of the main body comprises two mounting portions which are spaced apart in a direction of the output axis and which are arranged to support the transmission therebetween.

11. The device according to claim 10 wherein the two mounting portions are arranged to support the transmission reversibly therebetween in either one of a first position in which the output member is rotatable in a first direction about the output axis responsive to rotation of the control knob in a forward direction about the control axis or a second position in which the output member is rotatable in a second direction about the output axis opposite to the first direction responsive to rotation of the control knob in said forward direction about the control axis.

12. The device according to claim 1 wherein the transmission includes a transmission housing supporting the output member and the input member rotatably thereon and wherein the device further comprises:
an annular indexing member supported for rotation with the control knob and the input member about the control axis; and
an index marker supported adjacent a periphery of the annular indexing member, the index marker being supported on the transmission housing for rotation about the control axis relative to the transmission housing independently of the annular indexing member and control knob.

13. The device according to claim 12 wherein there is provided a set screw arranged to selectively fix orientation of the index marker relative to the transmission housing.

14. The device according to claim 13 wherein the set screw is located diametrically opposite the index marker about the control axis.

15. The device according to claim 1 further comprising:
an index marker supported on the main body;
an indexing mount supported on the input member for rotation with the input member and the control knob about the control axis; and
an annular indexing member arranged to be supported on the indexing mount for rotation therewith relative to the index marker supported on the main body;
the index mount being arranged to support the annular indexing member thereon in only one relative orientation and such that the annular indexing member is readily removable from the index mount.

16. The device according to claim 15 wherein at least one of the index mount and the annular indexing member comprises at least one magnetic coupling element arranged to magnetically support the annular indexing member on the index mount.

17. The device according to claim 15 wherein there is provided a plurality of magnetic coupling elements supported circumferentially about the index mount and the annular indexing member in alignment with one another, at least some of the magnetic coupling elements on each of the index mount and the annular indexing member having a magnetic flux oriented in a different direction relative to one another such that the magnetic coupling elements are arranged to magnetically couple the annular indexing member to the index mount in only one relative orientation.

18. A focussing accessory device for use with a video camera system including a mounting rail extending in a longitudinal direction along a rail axis, a camera body fixed relative to the mounting rail and a lens coupled to the camera body and supported on the mounting rail so as to be directed in the longitudinal direction for capturing an image, the lens having a focussing element arranged to provide adjustable focus to the lens and a focussing control rotatable about a focussing axis of the lens to adjust the focussing element of the lens, the device comprising:
a focussing ring arranged to be supported about the lens and coupled to the focussing control so as to be arranged to rotate with the focussing control about the focussing axis of the lens;
a main body extending between a rail mounting end and a working end;
a mount at the rail mounting end of the rail arranged to mount the main body onto the mounting rail;
a transmission supported on the main body adjacent the working end, the transmission comprising:
an output member supported for rotation about an output axis which is parallel to and spaced apart from the focussing axis such that the output member is arranged for meshing engagement with the focussing ring; and
an input member coupled to the output member such that the output member is rotated responsive to rotation of the input member; and
a control knob supported on the input member for rotation therewith relative to the main body about a control axis;
the working end of the main body comprising two mounting portions which are spaced apart in a direction of the output axis and which are arranged to support the transmission reversibly therebetween in either one of a first position in which the output member is rotatable in a first direction about the output axis responsive to rotation of the control knob in a forward direction about the control axis or a second position in which the output member is rotatable in a second direction about the output axis opposite to the first direction responsive to rotation of the control knob in said forward direction about the control axis.

19. A focussing accessory device for use with a video camera system including a mounting rail extending in a longitudinal direction along a rail axis, a camera body fixed relative to the mounting rail and a lens coupled to the camera body and supported on the mounting rail so as to be directed in the longitudinal direction for capturing an image, the lens having a focussing element arranged to provide adjustable focus to the lens and a focussing control rotatable about a focussing axis of the lens to adjust the focussing element of the lens, the device comprising:
a focussing ring arranged to be supported about the lens and coupled to the focussing control so as to be arranged to rotate with the focussing control about the focussing axis of the lens;
a main body extending between a rail mounting end and a working end;
a mount at the rail mounting end of the rail arranged to mount the main body onto the mounting rail;
a transmission supported on the main body adjacent the working end, the transmission comprising:
an output member supported for rotation about an output axis which is parallel to and spaced apart from the focussing axis such that the output member is arranged for meshing engagement with the focussing ring;
an input member coupled to the output member such that the output member is rotated responsive to rotation of the input member; and
a transmission housing supporting the output member and the input member rotatably thereon;
a control knob supported on the input member for rotation therewith relative to the main body about a control axis;
an annular indexing member supported for rotation with the control knob and the input member about the control axis; and
an index marker supported adjacent a periphery of the annular indexing member, the index marker being supported on the transmission housing for rotation about the control axis relative to the transmission housing independently of the annular indexing member and control knob.

20. A focussing accessory device for use with a video camera system including a mounting rail extending in a longitudinal direction along a rail axis, a camera body fixed relative to the mounting rail and a lens coupled to the camera body and supported on the mounting rail so as to be directed in the longitudinal direction for capturing an image, the lens having a focussing element arranged to provide adjustable focus to the lens and a focussing control rotatable about a focussing axis of the lens to adjust the focussing element of the lens, the device comprising:
a focussing ring arranged to be supported about the lens and coupled to the focussing control so as to be arranged to rotate with the focussing control about the focussing axis of the lens;
a main body extending between a rail mounting end and a working end;
a mount at the rail mounting end of the rail arranged to mount the main body onto the mounting rail;
a transmission supported on the main body adjacent the working end, the transmission comprising:
an output member supported for rotation about an output axis which is parallel to and spaced apart from the focussing axis such that the output member is arranged for meshing engagement with the focussing ring; and
an input member coupled to the output member such that the output member is rotated responsive to rotation of the input member;
a control knob supported on the input member for rotation therewith relative to the main body about a control axis;
an index marker supported on the main body;
an indexing mount supported on the input member for rotation with the input member and the control knob about the control axis; and
an annular indexing member arranged to be supported on the indexing mount for rotation therewith relative to the index marker supported on the main body;
the index mount being arranged to support the annular indexing member thereon in only one relative orientation and such that the annular indexing member is readily removable from the index mount.
